(19) United States
(12) Patent Application Publication
(10) Pub. No.: US 2026/0240132 A1
(43) Pub. Date: Aug. 20, 2026

(54) FISHING LINE GUIDE AND METHOD FOR PRODUCING FISHING GEAR ITEM

(71) Applicant: GLOBERIDE, INC., Tokyo (JP)

(72) Inventors: Kazuki KAWAI, Tokyo (JP); Kazuki KAWANO, Yokohama-shi, Kanagawa (JP); Yusuke ODAN, Yokohama-shi, Kanagawa (JP); Nobuki HIROOKA, Yokohama-shi, Kanagawa (JP)

(73) Assignee: GLOBERIDE, INC., Tokyo (JP)

(21) Appl. No.: 19/159,727

(22) PCT Filed: Jan. 22, 2024
(86) PCT No.: PCT/JP2024/001718

§ 371 Date: Aug. 26, 2025

(30) Foreign Application Priority Data
Apr. 26, 2023 (JP) 2023-072801

(51) Int. Cl. A01K 87/04; B33Y 10/00; B33Y 80/00

(52) U.S. Cl. CPC A01K 87/04; B33Y 10/00; B33Y 80/00

(57) ABSTRACT

Provided is a light-weight fishing gear item with high mechanical strength. This fishing gear item is a fishing line guide of which a body part is composed of a fiber-containing resin composition, the body part having a rib.

### TECHNICAL FIELD

The present invention relates to, for example, a fishing line guide.

### BACKGROUND ART

A fishing line guide for guiding a fishing line is known.

The fishing line guide includes a frame and a guide ring. The frame includes a ring holding portion and a fixing portion. The ring holding portion and the fixing portion are integrally formed. The ring holding portion holds the guide ring. The fixing portion is attached to an outer peripheral surface of a fishing rod. A fishing line is inserted through the guide ring.

The frame is formed by pressing a metal plate. Examples of the metal include stainless steel and titanium. A metal fishing line guide is heavy. Its performance such as flexibility is poor. When a large number of metal fishing line guides are attached along an axial length direction of the fishing rod, the entire fishing rod becomes extremely heavy. A fishing rod that needs to be reduced in weight cannot provide desired performance.

From such viewpoints, fishing line guides made of fiber-reinforced plastic have been proposed (Japanese Patent No. 5,460,441, Japanese Patent No. 5514061).

### CITATION LIST

### Patent Documents

Patent Document 1: Japanese Patent No. 5,460,441
Patent Document 2: Japanese Patent No. 5,514,061

### DISCLOSURE OF THE INVENTION

### Technical Problem

The fishing line guides disclosed in the patent documents are excellent.

However, a fishing line guide that is lighter in weight and has greater mechanical strength has been demanded.

A technology capable of easily manufacturing a fishing line guide having the above-described features has been demanded.

An object of the present invention is to provide a fishing line guide that is lightweight and has greater mechanical strength. It is an object of the present invention to provide a technology capable of easily manufacturing a fishing line guide having the above-described features.

### Solution to Problem

The present invention proposes a fishing line guide, wherein
a main body portion of the fishing line guide is made of a fiber-containing resin composition, and
the main body portion includes a rib.

The present invention proposes the fishing line guide, wherein preferably the main body portion includes a substantially ring-shaped portion and a substantially Y-shaped portion, tip end portions of diverged portions of the substantially Y-shaped portion are connected to the substantially ring-shaped portion, and a rib is formed on the diverged portion.

The present invention proposes the fishing line guide, wherein preferably an inner part of the diverged portion is thin, an outer part of the diverged portion is thick, and the thick part is a rib.

The present invention proposes the fishing line guide, wherein preferably the main body portion includes a substantially ring-shaped portion and a substantially Y-shaped portion, tip end portions of diverged portions of the substantially Y-shaped portion are connected to the substantially ring-shaped portion, and a rib is formed on the substantially ring-shaped portion position sandwiched by the diverged portions.

The present invention proposes the fishing line guide, wherein preferably a ring outer part of the substantially ring-shaped portion at a position sandwiched by the diverged portions is thin, a ring inner part of the substantially ring-shaped portion at the sandwiched position is thick, and the thick part is a rib.

The present invention proposes the fishing line guide, wherein preferably extending directions of the diverged portions in the substantially Y-shaped portion are directions substantially tangent to the substantially ring-shaped portion.

The present invention proposes the fishing line guide, wherein preferably widths of the diverged portions of the substantially Y-shaped portion are wider than a width of the substantially ring-shaped portion.

The present invention proposes the fishing line guide, wherein preferably a thickness at the rib part of the diverged portion of the substantially Y-shaped portion is substantially the same as a thickness of the substantially ring-shaped portion.

The present invention proposes the fishing line guide, wherein preferably a width of a base portion of the substantially Y-shaped portion substantially monotonically decreases from a tip end portion toward a base end portion.

The present invention proposes the fishing line guide, wherein preferably a thickness of the base portion of the substantially Y-shaped portion substantially monotonically increases from the tip end portion toward a bent position.

The present invention proposes the fishing line guide, wherein preferably the thickness of the base portion of the substantially Y-shaped portion decreases from a position beyond the bent position toward the base end portion.

The present invention proposes the fishing line guide, wherein preferably the fibers are present across the substantially ring-shaped portion and the substantially Y-shaped portion.

The present invention proposes the fishing line guide, wherein preferably carbon fibers are used as the fibers.

The present invention proposes the fishing line guide, wherein preferably the fibers have fibers with a fiber length of 1 cm or more.

The present invention proposes the fishing line guide, wherein preferably a thermosetting resin is used as the resin.

The present invention proposes the fishing line guide, wherein preferably the resin composition satisfies (amount of the resin)/(amount of the resin+amount of the fibers)=30/100 to 60/100.

The present invention proposes the fishing line guide wherein preferably the fishing gear item has a water absorption rate of 2.0% or less.

The present invention proposes a method for manufacturing a fishing gear item, the method includes:
a shaping step of shaping a resin composition having fibers by using a 3D printer; and
a heating and pressurizing step of heating and pressurizing a shaped object obtained in the shaping step.

The present invention proposes a method for manufacturing a fishing gear item a main body portion of which is made of a fiber-containing resin composition, the method includes:
a shaping step of shaping a resin composition having fibers by using a 3D printer; and
a heating and pressurizing step of heating and pressurizing a shaped object obtained in the shaping step.

The present invention relates to the method for manufacturing a fishing gear item, preferably using a mold for the pressurizing step, wherein
the mold includes a half-mold A and a half-mold B,
in the half-mold A and the half-mold B, a recess having no corners on a concave surface is formed on each of the surfaces opposed to each other of the half-mold A and the half-mold B, and
the shaped object is disposed in the recess of the half-mold A, and is then covered with the half-mold B, heated and pressurized.

The present invention proposes the method for manufacturing a fishing gear item, wherein preferably the heating and pressurizing step is a step in which the shaped object is disposed in a mold and heated and pressurized.

The present invention proposes the method for manufacturing a fishing gear item, wherein preferably the heating and pressurizing step includes a first pressurizing step and a second pressurizing step, and the second pressurizing step is a step of pressurizing a product obtained through the first pressurizing step under heating and is a step of obtaining a product a volume of which is smaller than a volume of the product obtained through the first pressurizing step.

The present invention proposes the method for manufacturing a fishing gear item, wherein preferably the shaping step is a step of obtaining a product in which all of the fibers are not integrally bonded by the resin but are partially separated.

The present invention proposes the method for manufacturing a fishing gear item, wherein preferably the first pressurizing step is a step of pressurizing a product obtained through the shaping step and is a step of obtaining a product in which most of the fibers are integrally bonded by the resin and which has a curved portion.

The present invention proposes the method for manufacturing a fishing gear item, wherein preferably the first pressurizing step is a step in which a plurality of products obtained through the shaping step are stacked and pressurized.

The present invention proposes the method for manufacturing a fishing gear item, wherein preferably a pressure in the first pressurizing step is smaller than a pressure in the second pressurizing step.

The present invention proposes the method for manufacturing a fishing gear item, preferably satisfying (volume of a product obtained through the first pressurizing step)/(volume of a product obtained through the second pressurizing step)≤2.5.

The present invention proposes the method for manufacturing a fishing gear item, preferably satisfying 1.0<(volume of a product obtained through the first pressurizing step)/(volume of a product obtained through the second pressurizing step)≤2.5.

The present invention proposes the method for manufacturing a fishing gear item, wherein preferably the first pressurizing step is a step of pressurizing at a temperature equal to or higher than a melting temperature of the resin in the ½ method using a flow tester CFT-500D (manufactured by Shimadzu Corporation).

The present invention proposes the method for manufacturing a fishing gear item, wherein preferably the second pressurizing step is a step of pressurizing at a temperature equal to or higher than a melting temperature of the resin in the ½ method using a flow tester CFT-500D (manufactured by Shimadzu Corporation).

The present invention proposes the method for manufacturing a fishing gear item, wherein preferably a heating method in the first pressurizing step is a non-contact heating method.

The present invention proposes the method for manufacturing a fishing gear item, wherein preferably the non-contact heating method is an induction heating method.

The present invention proposes the method for manufacturing a fishing gear item, wherein preferably the first pressurizing step uses a mold of a non-magnetic material.

The present invention proposes the method for manufacturing a fishing gear item, wherein the heating method in the second pressurizing step is preferably a contact heating method.

The present invention proposes the method for manufacturing a fishing gear item, wherein preferably the second pressurizing step uses a mold of a metal material.

The present invention proposes the method for manufacturing a fishing gear item, wherein preferably the fibers have fibers with a fiber length of 1 cm or more.

The present invention proposes the method for manufacturing a fishing gear item, wherein preferably the fibers are conductive fibers.

The present invention proposes the method for manufacturing a fishing gear item, wherein preferably the conductive fibers are carbon fibers.

The present invention proposes the method for manufacturing a fishing gear item, wherein preferably the resin composition satisfies (amount of the fibers)/(amount of the resin+amount of the fibers)=30/100to 60/100.

The present invention proposes the method for manufacturing a fishing gear item, wherein preferably a ratio of the fibers and the resin to be used in the shaping step is (volume of the resin)/(volume of the fibers+volume of the resin)=30/100to 55/100.

The present invention proposes the method for manufacturing a fishing gear item, wherein preferably the resin is a thermosetting resin.

The present invention proposes the method for manufacturing a fishing gear item, wherein preferably the resin is a thermoplastic resin.

The present invention proposes the method for manufacturing a fishing gear item, wherein preferably the resin composition has a water absorption rate of 2.0% or less.

The present invention proposes the method for manufacturing a fishing gear item, preferably using a mold including at least a lower mold, an intermediate mold, and an upper mold in the first pressurizing step, wherein
the lower mold includes a curved surface portion,
the upper mold includes a curved surface portion, the curved surface portion of the upper mold corresponds to the curved surface portion of the lower mold,
the intermediate mold includes a guide portion that guides a product obtained through the additive manufacturing step to the lower mold side,
the intermediate mold is disposed with respect to the lower mold, the product obtained through the additive manufacturing step is disposed with respect to the intermediate guide portion, and the upper mold is disposed with respect to the product disposed with respect to the guide portion, and curved portions corresponding to the curved surface portions are formed on the product present between the curved surface portion of the lower mold and the curved surface portion of the upper mold by applying a pressure between the lower mold and the upper mold.

The present invention proposes the method for manufacturing a fishing gear item, wherein preferably the intermediate mold has a flat surface at an upper surface and a curved surface portion corresponding to the curved surface portion of the lower mold at a lower surface,
the guide portion is a void portion provided in the vertical direction of the intermediate mold, and
the void portion is connected to the curved surface portion of the lower mold.

The present invention proposes the method for manufacturing a fishing gear item, preferably using a mold including at least a lower mold and an upper mold in the second pressurizing step, wherein
the upper mold and the lower mold include a cavity corresponding to a shape of a final product when the upper mold is disposed with respect to the lower mold,
the cavity includes a groove formed on a surface of the upper mold and a groove formed on a surface of the lower mold,
the groove has a substantially U-shaped cross section, and
a product obtained through the first pressurizing step is disposed on the lower mold, the upper mold is disposed from above the product disposed on the lower mold, and a pressure is applied between the lower mold and the upper mold.

The fishing gear item obtained by the manufacturing method is, for example, a fishing line guide.

### Advantageous Effects of the Invention

A fishing gear item according to the present invention is lightweight and has greater mechanical strength.

A fishing gear item having the above-described features can be easily manufactured.

### BRIEF DESCRIPTION OF DRAWINGS

FIG. 1 A perspective view of a fishing line guide according to the present invention from one surface (front surface) side.

FIG. 2 A perspective view of the fishing line guide according to the present invention from the other surface (back surface) side.

FIG. 3 A cross-sectional view of the fishing line guide according to the present invention.

FIG. 4 A cross-sectional view of the fishing line guide according to the present invention.

FIG. 5 A perspective view of a lower half mold.

FIG. 6 A perspective view of an upper half mold in a vertically inverted state.

### DESCRIPTION OF EMBODIMENTS

Embodiments of the present invention will be described.

A first aspect of the present invention relates to a fishing gear item. The fishing gear item is, for example, a fishing line guide. A main body portion of the fishing line guide is made of a fiber-containing resin composition. The main body portion includes ribs (thick parts). Fishing line guides previously proposed have no ribs (rib structures). Conventional fishing line guides have a constant thickness. On the other hand, the present invention has ribs (rib structures). The fishing line guide of the present invention includes thick portions and thin portions. The thick portions are ribs. Accordingly, the mechanical strength has been improved. Moreover, the fishing line guide of the present invention provided with the ribs (rib structures) is lighter in weight than a conventional fishing line guide (not provided with the ribs (rib structures)) provided with mechanical strength equivalent to the mechanical strength of the fishing line guide of the present invention.

A thickness of a portion (thin portion) that is not the rib needs to be thinner than a thickness of the rib (thick portion). Weight reduction can be achieved just by this.

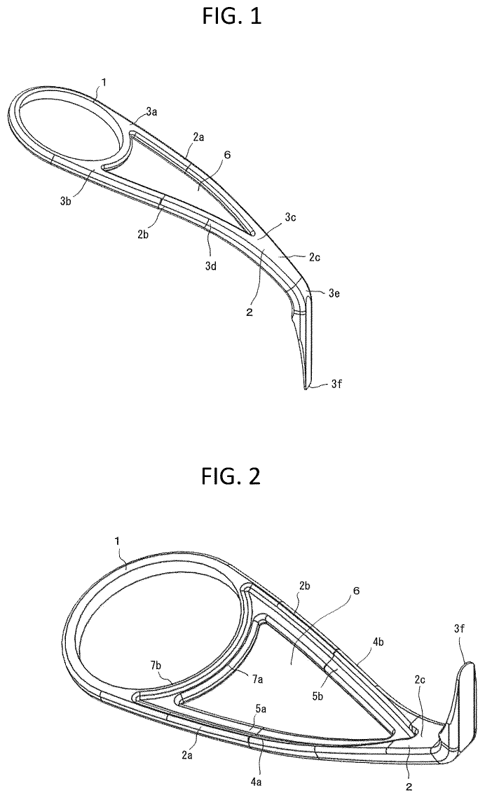

The thickness is a dimension in the vertical direction when a surface of a substantially Y-shaped portion of the fishing line guide is placed in a horizontal direction. The thickness is a dimension in the vertical direction in FIGS. 1, 2, and 3.

The width is a dimension in a direction orthogonal to the thickness direction.

The thickness direction and the width direction described hereinafter are also handled in accordance with the above description.

The main body portion preferably includes a substantially ring-shaped portion. A fishing line is inserted through the substantially ring-shaped portion. The main body portion preferably includes a support portion. The support portion is attached to a fishing rod.

The support portion preferably includes a base portion (stem portion) located on the fishing rod side. The support portion preferably includes branch portions (diverged portions: tip ends of the branch portions (diverged portions) are connected to the ring-shaped portion) diverging at a tip of the base portion (stem portion).

The branch portion has a width that is about a half (or a half or less) of the base portion. A thickness of the branch portion is substantially the same as a thickness of a portion where the branch portion is connected to the base portion.

The substantially ring-shaped portion needs to have an annular shape, and may have a circular shape, an elliptical shape, or a polygonal shape such as a triangular shape and a quadrangular shape. The substantially ring-shaped portion may be partially interrupted (may have an open annular shape (substantially C-shaped)). That is, it does not necessarily have a closed form. However, it generally has a closed annular shape.

The substantially ring-shaped portion has a thin portion (a portion having a small thickness). Accordingly, weight reduction has been achieved. The substantially ring-shaped portion has a thick portion (a portion having a large thickness). This thick portion is a rib.

The support portion has, for example, a substantially Y shape. The tip end portions of the diverged portions (branch portions) of the substantially Y shape are connected to the substantially ring-shaped portion. The substantially ring-shaped portion is supported by the substantially Y-shaped portion. The substantially Y-shaped portion also includes the following forms. The tip end side of the substantially Y-shaped portion has a substantially V-shape. That is, although there are two tip ends, there may be three or more tip ends. The number of tip ends may be any number, but practically, two or three. This is because the larger the number, the heavier the weight.

When a force from the fishing line acts on the substantially ring-shaped portion, the force acts on the tip end portions of the support portion (diverged portions: branch portions) that supports the substantially ring-shaped portion. Since the number of support portions (diverged portions: branch portions) is not one but plural, that is, since the support portion (tip end portions to support) forms a substantially Y shape, the support portion is hardly warped (twisted).

Although the support portion is hardly warped (twisted), since the tip end portions of the support portion (diverged portions: branch portions) are formed by division into, for example, two, the mechanical strength of each support portion (diverged portion: branch portion) decreases. Therefore, in order to compensate for the decrease in mechanical strength, a rib is formed on the diverged portion (branch portion). An inner part of the diverged portion is thin. An outer part of the diverged portion is thick. The thick part is a rib. The reason why it is preferable to provide the rib structure as described above is as follows. This is because when the rib structure (that is, a structure in which a rib is provided not at an inner position but at an outer position) is adopted, resistance against a deformation pressure such as twisting is greater than that of a rib structure in which the inner part of the diverged portion is thick and the outer part is thin.

The rib structure may be configured on a portion other than the diverged portion (branch portion). For example, a rib is formed on the substantially ring-shaped portion at a position sandwiched between the diverged portions. A ring outer part of the substantially ring-shaped portion at a position sandwiched by the diverged portions is thin, and a ring inner part of the substantially ring-shaped portion at the sandwiched position is thick. The thick part is a rib. Since the rib structure in which the inner part of the diverged portion is thin, is adopted, the ring outer part is formed to be thin. A configuration opposite to the above becomes structurally complicated.

Extending directions of the diverged portions (branch portions) of the substantially Y-shaped portion are preferably directions substantially tangent to the substantially ring-shaped portion. The reason for this is as follows. When connection directions between the diverged portions and the substantially ring-shaped portion are directions substantially tangent to the substantially ring-shaped portion, the diverged portions can securely receive a force applied to the substantially ring-shaped portion.

Widths of the diverged portions (branch portions) of the substantially Y-shaped portion are preferably wider than a width of the substantially ring-shaped portion. The reason for this is as follows. When the widths of the diverged portions (branch portions) are large, the mechanical strength of the diverged portions is increased. The diverged portions can receive a force applied to the substantially ring-shaped portion without difficulty.

The thickness at the rib of the diverged portion (branch portion) of the substantially Y-shaped portion is preferably substantially the same as the thickness of the substantially ring-shaped portion. The reason for this is as follows. By setting the same thickness, the structure is simplified.

The width of the base portion (stem portion: a part on a root side from which the diverged portions (branch portions) are derived) of the substantially Y-shaped portion preferably substantially monotonically decreases from a tip end portion (a portion where the diverged portions are connected to each other) toward the base end portion (bent position). The thickness of the base portion (stem portion) of the substantially Y-shaped portion preferably substantially monotonically increases from the tip end portion toward the bent position. The reason for this is as follows. This is because the mechanical strength of the base portion (stem portion) can be secured by increasing the thickness although the width decreases. That is, the base portion can securely receive a force applied to the substantially ring-shaped portion.

The thickness of the base portion (stem portion) of the substantially Y-shaped portion preferably decreases from a position beyond the bent position toward the base end portion. The reason for this is as follows. In order to easily fix the base portion to the fishing rod, the thickness from a substantially intermediate position between the bent position and the base end portion to the base end portion is reduced.

The fibers are present across the substantially ring-shaped portion and the substantially Y-shaped portion.

As a structure related to the fishing line guide, the contents disclosed in Patent Document 1 (Japanese Patent No. 5460441) and Patent Document 2 (Japanese Patent No. 5514061) can be appropriately adopted. For example, the contents disclosed in Patent Document 1 and Patent Document 2 can be adopted for the structure of the main body portion as necessary. For example, a ring made of metal (for example, Ti, Al, Mg, SUS, or the like) or ceramic can be provided in the substantially ring-shaped portion. The base portion (stem portion) of the substantially Y-shaped portion can be structured to be easily attached to a fishing rod, for example, to have a bent shape.

Reinforcing fibers are used as the fibers of the fiber-containing resin composition constituting the main body portion of the fishing line guide. Examples of the fibers include inorganic fibers. Organic fibers may also be used. Both may be used in combination. The fibers only need to satisfy the following requirements. (length of ¼ or more of one round of the substantially ring-shaped portion)≤(length of the fibers in longitudinal direction). Alternatively, (length of ½ or more of length from the base end of the substantially Y-shaped portion to one diverged portion end)≤(length of the fibers in longitudinal direction). Preferably, (length surrounding a part of the circumference of the substantially ring-shaped portion from the base end of the substantially Y-shaped portion)≤(length of the fibers in longitudinal direction). A specific numerical value is, for example, 1 cm or more although it depends on a size of the main body portion. It is preferably 2 cm or more. It is more preferably 3 cm or more. it is further preferably 6 cm or more. Although an average fiber length of the continuous reinforcing fibers used in the present invention is not particularly limited, from the viewpoint of improving the moldability, an average fiber length in a range of 0.05 to 20, 000 m is preferable. It is more preferably 100 to 10, 000 m. It is further preferably 1000 to 7000 m. A fiber length of more than 3 cm (6 cm) and a fiber length of 3 cm (6 cm) or less may be adopted in combination. The fiber length in the present invention is a weight-average fiber length unless otherwise specified. An average fiber diameter of the fibers is preferably 3 μm or more. it is more preferably 4 μm or more. It is further preferably 5 μm or more. It is preferably 50 μm or less. It is more preferably 20 μm or less. It is further preferably 12 μm or less. The average fiber diameter is a diameter of a single yarn.

Examples of the inorganic fibers include carbon fibers, silicon carbide fibers, alumina fibers, boron fibers, glass fibers, and metal fibers. The inorganic fibers are not limited to these. Not only one kind but a plurality of kinds of fibers may be used in combination. From the viewpoint of mechanical strength and lightweight properties, carbon fibers are preferable.

Examples of the carbon fibers include polyacrylonitrile (PAN)-based carbon fibers, petroleum/coal pitch-based carbon fibers, rayon-based carbon fibers, cellulose-based carbon fibers, lignin-based carbon fibers, phenol-based carbon fibers, and vapor-grown carbon fibers. One kind or two or more kinds of these are appropriately used. The carbon fibers to be used preferably have a tensile modulus of 100 GPa to 1000 GPa. The form of the carbon fibers is not particularly limited. The form of the carbon fibers may be continuous fibers or discontinuous fibers. Examples of the continuous fibers include fibers in which carbon fibers are arranged in one direction (unidirectional material). Examples in a case using discontinuous fibers include a material in which carbon fibers are arranged so as to be oriented in a specific direction in the resin, a material in which carbon fibers are arranged by being randomly dispersed in an in-plane direction in the resin, and the like. The carbon fibers may be single-filament fibers, fiber bundles, or a mixture of these. Carbon fibers are generally in the form of fiber bundles in which thousands to tens of thousands of filaments are assembled. In the case where carbon fiber bundles are used as the carbon fibers, when the carbon fiber bundles are used as they are, entangled portions of the fiber bundles become locally thick, and it may be difficult to obtain a carbon fiber-reinforced resin processed product having a thin end face. Therefore, when carbon fiber bundles are used as the carbon fibers, it is preferable that the carbon fiber bundles are used after being widened or opened.

Examples of the metal fibers include Al fibers, Au fibers, Ag fibers, Fe fibers, and stainless steel fibers.

Examples of the organic fibers include aramid fibers, aromatic polyamide fibers, cellulose fibers, polyethylene fibers, and poly (paraphenylene benzobisoxazole) fibers (Zylon (manufactured by Toyobo Co., Ltd.)).

The fibers may be treated with a treatment agent. Examples of the treatment agent include a sizing agent. A surface preparation agent may be used. For example, a treatment agent disclosed in Japanese Patent No. 4,894,982 may be used. It is advantageous when the treatment agent on the fiber surface reacts with a functional group (reactive group: polar group) of the resin.

The treatment agent is selected from a group consisting of, for example, an epoxy resin, a urethane resin, a silane coupling agent, a water-insoluble polyamide resin, and a water-soluble polyamide resin. It is preferably selected from a group consisting of an epoxy resin, a urethane resin, a Water-insoluble polyamide resin, and a water-soluble polyamide resin. One kind or two or more kinds may be used.

As the resin of the fiber-containing resin composition constituting the main body portion of the fishing line guide, various resins can be used. The main body portion is manufactured by, for example, an additive manufacturing technology described later. Therefore, a resin (matrix resin) that can be used in the Additive Manufacturing technology is preferably used. Examples of such a resin include a thermoplastic resin. A thermosetting resin may be used. Either one may be used. They may be used in combination. One kind or two or more kinds of the resins may be used. The form of the resin may be a film form (or a sheet form). The form of the resin may be a fiber (yarn or filament) form. When the resin is fibrous, it is a so-called combined filament yarn (see, e.g., WO2016/167136A1) in the present invention. In the case of a combined filament yarn, the technology disclosed in WO2016/167136A1 can be adopted. The resin preferably has a functional group (reactive group: polar group). A resin having no functional group (reactive group: polar group) can also be used.

The thermoplastic resin may be composed only of a thermoplastic resin or may be mainly composed of a thermoplastic resin. In the present invention, either case may be adopted. In the present invention (the present specification), unless otherwise specified, the term “thermoplastic resin” includes both a resin composed only of a thermoplastic resin and a resin mainly composed of a thermoplastic resin. The resin mainly composed of a thermoplastic resin is a resin containing a thermoplastic resin of 50 mass % or more. The content is preferably 80 masso more. The content is further preferably 90 mass or more.

The thermosetting resin may be composed only of the thermosetting resin or may be mainly composed of the thermosetting resin. In the present invention, either case may be adopted. In the present invention (the present specification), unless otherwise specified, the term “thermosetting resin” includes a resin composed only of a thermosetting resin and a resin mainly composed of a thermosetting resin. The resin mainly composed of a thermosetting resin is a resin containing a thermosetting resin of 50 mass % or more. The content is preferably 80 mass % or more. The content is further preferably 90 mass % or more.

Examples of the thermosetting resin include an epoxy resin, a vinyl ester resin, an unsaturated polyester resin, a diallyl phthalate resin, a phenol resin, a maleimide resin, a cyanate resin, a benzoxazine resin, and a dicyclopentadiene resin.

Examples of the thermoplastic resin include a polyolefin resin, a polystyrene resin, a thermoplastic polyamide resin, a polyester resin, a polyacetal resin (polyoxymethylene resin), a polycarbonate resin, a (meth)acrylic resin, a polyarylate resin, a polyphenylene ether resin, a polyimide resin, a polyether nitrile resin, a phenoxy resin, a polyphenylene sulfide resin, a polysulfone resin, a polyketone resin, a polyether ketone resin, a thermoplastic urethane resin, a fluorine-based resin, and a thermoplastic polybenzimidazole resin.

Examples of the polyolefin resin include a polyethylene resin, a polypropylene resin, a polybutadiene resin, a polymethylpentene resin, a vinyl chloride resin, a vinylidene chloride resin, a vinyl acetate resin, and a polyvinyl alcohol resin.

Examples of the polystyrene resin include a polystyrene resin, an acrylonitrile-styrene resin (AS resin), and an acrylonitrile-butadiene-styrene resin (ABS resin).

Examples of the polyamide resin include a polyamide 6 resin (nylon 6), a polyamide 11 resin (nylon 11), a polyamide 12 resin (nylon 12), a polyamide 46 resin (nylon 46), a polyamide 66 resin (nylon 66), and a polyamide 610 resin (nylon 610). Examples of nylon (hereinafter, sometimes abbreviated as “PA”) which is one of the polyamide-based resins include PA6 (also referred to as polycaproamide, polycaprolactam, polyε-caprolactam), PA26 (polyethylene adipamide), PA46 (polytetramethylene adipamide), PA66 (polyhexamethylene adipamide), PA69 (polyhexamethylene azepamide), PA610 (polyhexamethylene sebacamide), PA611 (polyhexamethylene undecamide), PA612 (polyhexamethylene dodecamide), PA11 (polyundecamide), PA12 (polydodecanamide), PA1212 (polydodecamethylene dodecamide), PA6T (polyhexamethylene terephthalamide), PA6I (polyhexamethylene isophthalamide), PA912 (polynonamethylene dodecamide), PA1012 (polydecamethylene dodecamide), PA9T (polynonamethylene terephthalamide), PA9I (polynonamethylene isophthalamide), PA10T (polydecamethylene terephthalamide), PA10I (polydecamethylene isophthalamide), PA11T (polyundecamethylene terephthalamide), PA11I (polyundecamethylene isophthalamide), PA12T (polydodecamethylene terephthalamide), PA12I (polydodecamethylene isophthalamide), polyamide XD6 (polymetaxylylene adipamide), and polyamide XD10 (polyxylylene sebacamide).

Examples of the polyester resin include a polyethylene terephthalate resin, a polyethylene naphthalate resin, a polybutylene terephthalate resin, a polytrimethylene terephthalate resin, and liquid crystal polyester.

Examples of the (meth)acrylic resin include polymethyl methacrylate.

Examples of the modified polyphenylene ether resin include modified polyphenylene ether.

Examples of the thermoplastic polyimide resin include thermoplastic polyimide, a polyamideimide resin, and a polyetherimide resin.

Examples of the polysulfone resin include a modified polysulfone resin and a polyethersulfone resin.

Examples of the polyether ketone resin include a polyether ketone resin, a polyether ether ketone resin, and a polyether ketone ketone resin.

Examples of the fluorine-based resin include polytetrafluoroethylene.

The resin of the fiber-containing resin composition constituting the main body portion of the fishing line guide is preferably a thermosetting resin. The thermosetting resin is particularly preferably a thermosetting resin with a water absorption rate of 2.0% or less.

The reason why the water absorption rate is preferably 2.0% or less is as follows. The fishing line guide is often exposed to water during use. Water absorption occurs upon contact with water. As a result, the weight increases. This is not preferable from the viewpoint of lightweight properties.

The content ratio (combination ratio) of the resin and the fibers of the fiber-containing resin composition constituting the main body portion of the fishing line guide is preferably as follows from the viewpoint of lightweight properties and mechanical strength. For example, the higher the amount of carbon fibers, the higher the mechanical strength. However, the lightweight properties are lost. Conversely, the lower the amount of carbon fibers, the lower the mechanical strength. From such a viewpoint, a preferable ratio of these is as follows. Preferably, 20/100≤(volume of the resin)/(volume of the fibers+volume of the resin). More preferably, 25/100≤(volume of the resin)/(volume of the fibers+volume of the resin). Further preferably, 30/100≤(volume of the resin)/(volume of the fibers+volume of the resin). Even more preferably, 35/100≤(volume of the resin)/(volume of the fibers+volume of the resin). Preferably, (volume of the resin)/(volume of the fibers+volume of the resin)≤55/100. More preferably, (volume of the resin)/(volume of the fibers+volume of the resin)≤50/100. Further preferably, (volume of the resin)/(volume of the fiber+volume of the resin)≤45/100. Even more preferably, (volume of the resin)/(volume of the fibers+volume of the resin)≤40/100.

A second aspect of the invention relates to a method for manufacturing a fishing gear item. For example, the present invention relates to a method for manufacturing the fishing line guide. The method includes a shaping (modeling) step of shaping (modeling) a resin composition having fibers (for example, containing fibers) by using a 3D printer. The method includes a heating and pressurizing step of heating and pressurizing a shaped object obtained in the shaping (modeling) step.

Additive manufacturing technologies (Additive Manufacturing: 3D printer modeling technology) are known. These technologies are described in “2013 Patent Application Technology Trends Investigation Report (Outline) 3D Printer” as follows. A 3D printer (Additive Manufacturing) means a process of creating an object from numerical representation of a three-dimensional shape by depositing a material. This is realized by stacking a layer on the top of a layer in many cases. Expression of a 3D printer is used by contrast to two-dimensional output on paper. In ASTMF2792-12a (Standard Terminology for Additive Manufacturing Technologies), a term “Additive Manufacturing” is used.

It was difficult to manufacture a fiber-reinforced resin product having a three-dimensional shape (not a sheet (flat-plate: planar) shape) only by the additive manufacturing technology. In particular, when the amount of fibers was increased as much as possible (the amount of resin was relatively reduced) in order to improve the mechanical strength, it was difficult to manufacture the product only by the additive manufacturing technology.

Therefore, for manufacturing of the fishing gear item, a shaped object shaped by the additive manufacturing technology is heated and pressurized.

The shaping (modeling) step (additive manufacturing step) is a step in which an additive manufacturing technology is used. In the additive manufacturing step, for example, an additive manufacturing apparatus including a nozzle is used. In the step, a resin (plastic) and fibers are used. In the step, a resin (a resin serving as a matrix) and fibers may be supplied (discharged) from separate nozzles. The respective materials may be simultaneously supplied (discharged). They may be supplied (discharged) with a time difference. A fiber-reinforced plastic material (material in which fibers are dispersed in a resin) may be supplied (discharged) from one nozzle. Through the above-described step, a fiber-reinforced plastic product having a desired shape has been obtained. In the additive manufacturing step, for example, an additive manufacturing technology using fused deposition modeling may be used. In the additive manufacturing step, for example, an additive manufacturing technology not including an applying and printing step of applying and printing an unsolidified coagulant on an upper surface of a laminate or a sheet surface bonded onto the laminate based on laminate region data in a predetermined cross section of a three-dimensional model, and a sticking step of superimposing and sticking together a sheet on which the unsolidified coagulant has been applied and printed and the laminate in a heat-retaining state, or not including a bonding step of laminating sheets having a surface on which a coagulant has been selectively applied and selectively bonding the sheets with the coagulant may be used, and an additive manufacturing technology in which fibers and a resin are used and molded may be used. In the additive manufacturing step, for example, an additive manufacturing technology not including a step of laminating and bonding a sheet on which a coagulant has been applied may be used, and an additive manufacturing technology in which fibers and a resin are used and molded may be used. The fishing gear item (for example, the fishing line guide) may be molded by one (one time) additive manufacturing step. The product A may be a union of parts A1, . . . , Ak (k is an integer not larger than n), . . . , and An (n is an integer not less than 2). In such a case, the part A1 is formed by one (one time) additive manufacturing step A1. Similarly, the part Ak is formed by one (one time) additive manufacturing step Ak. The part An is formed by one (one time) additive manufacturing step An. When the part A1, . . . , Ak, . . . , An formed by the additive manufacturing steps A1, . . . , Ak, . . . , An are combined, the combination has the same shape as a shape of the product A. That is, the additive manufacturing step required may be only one (may be performed only one time) or two or more (performed two or more times). Either case is acceptable.

In the shaping (modeling) step (additive manufacturing step), when the resin is a thermosetting resin, the temperature is preferably 0° C. or higher from the viewpoint of formability. The temperature is more preferably 10° C. or higher. The temperature is further preferably 20° C. or higher. The temperature is even more preferably 30° C. or higher. The temperature is preferably 350° C. or lower. The temperature is more preferably 150° C. or lower. The temperature is even more preferably 100° C. or lower. When the resin is a thermoplastic resin, the temperature is preferably 30° C. or higher from the viewpoint of formability. The temperature is more preferably 50° C. or higher. The temperature is even more preferably 100° C. or higher. There is no particular restriction on the upper limit. However, in general, the temperature is preferably 700° C. or lower. The temperature is more preferably 500° C. or lower. The temperature is further preferably 450° C. or lower. The temperature is even more preferably 400° C. or lower.

The product obtained through the additive manufacturing step has a substantially flat-plate shape. It does not have a three-dimensional shape (tridimensional shape). For example, the product does not have a three-dimensional shape such as having a flat surface portion and an intersecting surface portion intersecting the flat surface portion. It is not easy to obtain a product having the three-dimensional shape (tridimensional shape) only by an additive manufacturing technology. It is easy (comparatively easy) to obtain a substantially flat-plate-shaped product by an additive manufacturing technology. In the product obtained through the additive manufacturing step, when the amount of the fibers is large, all of the fibers have not been integrally (strongly: rigidly) bonded by the resin. It can also be said that the resin is a binder. Therefore, it will be difficult to obtain an integral (strong: rigid) bond between the fibers with a small resin amount. The product has the fibers partially separated. The fibers are only loosely connected to each other. The separation is intended to mean that the product (the product obtained through the additive manufacturing step) is not in one fixed form. The separation is intended to mean that, for example, when a force to bend the product into a substantially arch shape is applied to the product, the fibers are displaced. When all the fibers are integrally (strongly) bonded by the resin, for example, even when the force as described above is applied to the product, the fibers are not displaced. Of course, this does not hold true unless a force great enough to break the product is applied.

The pressurizing step (heating and pressurizing step) is preferably a step of pressurizing the shaped object disposed and heated in a mold. The pressurizing step may be performed in a plurality of batches. For example, the pressurizing step may be performed in two stages such as a first pressurizing step and a second pressurizing step. When the fiber content is high, the pressurizing step is preferably performed in a plurality of batches. The first pressurizing step is performed with a comparatively small pressure. The second time of the pressurizing step (second pressurizing step) is performed with a larger pressure than in the first time of the pressurizing step (first pressurizing step). The change of the pressurizing force in the pressurizing step from small to large may be stepwise or continuous. That is, the pressurizing force may gradually increase. Such a pressurization mode is also considered to be performed in a plurality of batches. The first pressurizing step is a step of pressurizing the product obtained through the additive manufacturing step. Most of the fibers are integrally bonded by the resin through the first pressurizing step. That is, the fibers are integrally bonded to each other strongly to some extent by the resin. When the fibers are integrally bonded by the resin, the fibers are less likely to be displaced even when a great force is applied to the product. Even when a great force is applied to the product subjected to the first pressurizing step, the product is hardly deformed. Of course, this does not hold true unless a force great enough to break the product is applied. On the other hand, when a great force is applied to the product that has been obtained through the additive manufacturing step, displacement of the fibers was likely to occur. The product obtained through the first pressurizing step has a curved portion. Therefore, the product has a three-dimensional shape. On the other hand, the product obtained through the additive manufacturing step has a flat-plate shape. Thus, in this stage, the product does not have a curved portion (a surface intersecting a plane). In the first pressurizing step, a two-dimensionally shaped product is formed into a three-dimensionally shaped product. When the force applied in the first pressurizing step is excessively great, the shape is easily lost. This is because the fibers in the product obtained through the additive manufacturing step have not been strongly integrated by the resin. When the fiber content increases, the product at the time of undergoing the additive manufacturing step is not strongly integrated in many cases. Therefore, it is preferable not to apply an excessively great force. That is, the force applied in the first pressurizing step is preferably smaller than the force applied to form a final product shape. In the first pressurizing step, a plurality of products obtained through the additive manufacturing step may be stacked and pressurized. Of course, only one product may be pressurized in some cases. The second pressurizing step is a step of pressurizing the product obtained through the first pressurizing step under heating. The force applied in the second pressurizing step is greater than the force applied in the first pressurizing step. That is, the force applied in the second pressurizing step is a force applied to form a final product shape. A volume of the product obtained through the second pressurizing step is smaller than a volume of the product obtained through the first pressurizing step. A pressure in the first pressurizing step is smaller than a pressure in the second pressurizing step. For example, (pressure in the first pressurizing step)/(pressure in the second pressurizing step) is 0.8 or less. For example, it is 0.7 or less. For example, it is 0.6 or less. For example, it is 0.5 or less. For example, it is 0.4 or less. For example, it is 0.02 or more. For example, it is 0.05 or more. For example, it is 0.1 or more. The pressure in the first pressurizing step is 0.8 kPa or more. For example, it is 4 kPa or more. For example, it is 8.0×105 kPa or less. For example, it is 4.0×105 kPa or less. The pressure in the second pressurizing step is 1 kPa or more. For example, it is 5 kPa or more. For example, it is 1.0×106 kPa or less. For example, it is 5.0×105 kPa or less. (volume of a product obtained through the first pressurizing step)/(volume of a product obtained through the second pressurizing step)≤2.5. For example, it is 2 or less. For example, it is 1.5 or less. For example, it is 1.05 or more. For example, it is 1.1 or more.

The pressurizing step is preferably performed under a heating condition. The reason is that when the temperature is higher than a normal temperature (room temperature: for example, 25° C.), the resin (resin composition) becomes soft. As a result, formability by pressurization has been improved.

The heating temperature needed to satisfy the following conditions.

For example, the temperature was equal to or higher than a melting temperature in the ½ method performed by using a flow tester CFT-500D (manufactured by Shimadzu Corporation) according to the manual accompanying this tester.

The temperature was preferably equal to or higher than {the melting temperature+10° C.}. The temperature was further preferably equal to or higher than {the melting temperature+20 C.}. The temperature was preferably equal to or lower than {the melting temperature+60° C.}. The temperature was further preferably equal to or lower than {the melting temperature+50° C.} . More preferably, the temperature was equal to or lower than {the melting temperature+40° C.}. Even more preferably, the temperature was equal to or lower than {the melting temperature+30°C.}.

In a case where the resin is a thermoplastic resin, for example, the temperature needs to exceed the melting temperature.

When the resin is a thermosetting resin, for example, the temperature needs to be lower than the curing temperature.

The melting temperature is also called a softening point (softening temperature). The temperature was determined by the following method. A constant load extrusion type capillary rheometer (rheology testing equipment: flow tester CFT-500D (manufactured by Shimadzu Corporation) ) was used, and a measurement was performed according to the manual accompanying this tester. In the present apparatus, a constant load is applied from the top of a measurement sample (a sample in this case is not a resin containing fibers but a resin containing no fibers.) by a piston. The measurement sample filled in a cylinder is heated and melted. The melted measurement sample is extruded from a die at the bottom of the cylinder. A flow curve indicating the relationship between a piston lowering amount and the temperature is obtained. The melting temperature in the ½ method described in the manual was calculated as follows. ½ of a difference between a lowering amount Smax of the piston at the time when the outflow is ended and a lowering amount Smin of the piston at the time when the outflow is started is obtained (this is defined as X. X=(Smax−Smin)/2). The temperature of the flow curve at the time when the lowering amount of the piston becomes X in the flow curve is the melting temperature in the ½ method.

For example, when the resin was an epoxy resin (thermosetting resin), the melting temperature (softening temperature) determined by the above-described method was about 70° C. When the resin was benzoxazine (thermosetting resin), the melting temperature (softening temperature) determined by the above-described method was about 80° C. When the resin was a cyanate resin (thermosetting resin), the melting temperature (softening temperature) determined by the above-described method was about 80° C.

When the resin was a thermosetting resin, the heating temperature was preferably a temperature of (curing temperature of resin−70° C.) or higher. The heating temperature was more preferably a temperature of (curing temperature of resin−60° C.) or higher. The heating temperature was further preferably a temperature of (curing temperature of resin−50° C.) or higher. Even more preferably, the heating temperature was a temperature of (curing temperature of resin−40° C.) or higher. The temperature was preferably a temperature of (curing temperature of resin+20°C.) or lower. The heating temperature was further preferably a temperature of (curing temperature of resin+10°C.) or lower. Even more preferably, the temperature was equal to or lower than the curing temperature of the resin. The curing temperature is a peak temperature in a DSC curve.

The thermal curing temperature of the epoxy resin (thermosetting resin) is about 120 to 180° C. The thermal curing temperature of the benzoxazine resin (thermosetting resin) is about 120 to 200° C. The thermal curing temperature of the cyanate resin (thermosetting resin) is about 150 to 250° C.

When the resin is a thermosetting resin, after curing may be performed.

A mold is used for the pressurizing steps. The mold includes a half-mold A and a half-mold B. In the half-mold A and the half-mold B, a recess (groove) having no corners on a concave surface is formed on each of the Surfaces opposed to each other of the half-mold A and the half-mold B. A shaped object obtained in the additive manufacturing step is disposed in the recess of the half-mold A. The half-mold B is covered thereon and pressurized. When the half-mold A and the half-mold B are combined, a space (cavity) formed by the recesses of the half-mold A and the half-mold B has a shape of the final product. The inner surface of the recess (groove) has no corners. Therefore, the product obtained by applying a pressure between the half-mold A and the half-mold B has no corners since the inner surface of the recess (groove) has no corners. In a case where the cavity is formed only of a groove formed on the upper surface of the half-mold A (when the half-mold B facing the recess (groove) of the half-mold A has a protrusion or is flat), even when the groove has no corners, corners are formed in the product obtained in this manner.

Hereinafter, the present invention will be described in detail. The following example is merely an example of the present invention. The present invention is not limited to the following Example. That is, modifications and application examples in which the features of the present invention are not significantly impaired are also included in the present invention.

### Example 1

A thermosetting resin (benzoxazine resin: manufactured by Aica Kogyo Co., Ltd.) was used. Carbon fibers (Pyrofil-TR-50S-12000-AD, 8000dtex, number of fibers: 12000f, fiber length: 6 m, manufactured by Mitsubishi Rayon Co., Ltd.) were used. The combination ratio was 40 parts by volume of the resin and 60 parts by volume of the carbon fibers.

A 3D printer (K8200 manufactured by Velleman) was used. An additive manufacturing technology was implemented (nozzle temperature: 135° C., stage temperature: 50° C.). Accordingly, a product X made of the composition was obtained. The product X obtained through the step of the additive manufacturing technology has a substantially flat-plate shape. The shape is not a three-dimensional shape (tridimensional shape). Since the product X has a relatively small amount of resin, all of the fibers are not integrally bonded by the resin. The fibers in the product X were partially separated.

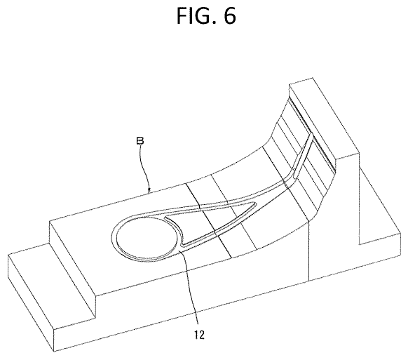

The product X obtained through the additive manufacturing step was disposed in a forming die. First, a pressure of 1.5×103 kPa was applied. The forming die is non-metallic. In this pressurizing step, non-contact heating (induction heating) was performed. A molded article Y having a three-dimensional shape was obtained. The pressed molded article Y was taken out of the forming die and disposed in a mold. The mold includes a metal half-mold A (see FIG. 5) and a metal half-mold B (see FIG. 6). Concave grooves (recesses) 11 and 12 are formed on the surfaces of the half-molds A and B. The shape of the space (cavity) formed by the concave grooves (recesses) 11 and 12 when the half-mold A and the half-mold B are combined is the shape of a final product Z. The concave surfaces of the concave grooves (recesses) 11 and 12 have no corners. The taken-out molded article Y was first disposed in the concave groove (recess) 11 of the half-mold A. The half-mold A in which the molded article Y was disposed was covered with the half-mold B. A half of the molded article Y is located in the groove 11 of the half-mold A, and the other half of the molded article Y is located in the groove 12 of the half-mold B. A pressure of 6.0×104 kPa was applied to the molded article Y in a state where the article was heated to 180° C.

A fishing line guide Z thus obtained is shown in FIGS. 1, 2, 3 and 4.

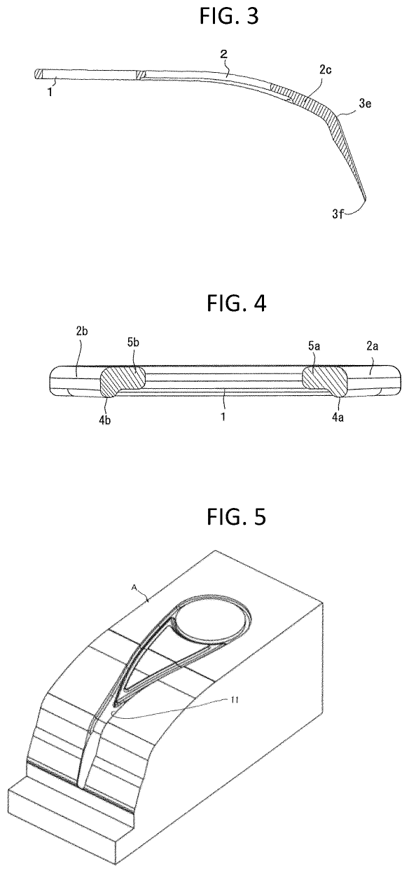

FIG. 1 is a perspective view of the fishing line guide Z. FIG. 2 is a perspective view of the fishing line guide Z as viewed from a surface opposite to that in FIG. 1. FIG. 3 is a cross-sectional view of the fishing line guide Z in the state illustrated in FIG. 1 taken along a line connecting an apex of a substantially ring-shaped portion 1 of the fishing line guide Z and a base end portion 3f of a substantially Y-shaped portion 2. FIG. 4 is a cross-sectional view taken along a line orthogonal to the cross-sectional line in FIG. 3 crossing an opening 6 of the fishing line guide Z.

In each figure, 1 denotes a substantially ring-shaped portion (inner diameter (diameter) of the ring: about 20.5 mm, outer diameter (diameter) of the ring: about 23.7 mm, thickness: about 2.3 mm, width: about 1.6 mm) through which the fishing line will be inserted.

2 denotes a substantially Y-shaped portion. A tip end side of the substantially Y-shaped portion 2 has a diverged structure. That is, the substantially Y-shaped portion 2 has two diverged portions (branch portions) 2a and 2b on the tip end side. The tip end portions 3a and 3b of the diverged portions 2a and 2b are connected to the substantially ring-shaped portion 1. The extending directions of the diverged portions 2a and 2b are directions tangent to the substantially ring-shaped portion 1. Since the connection directions between the diverged portions 2a and 2b and the substantially ring-shaped portion 1 are the directions substantially tangent to the substantially ring-shaped portion 1, the diverged portions 2a and 2b could receive a force applied to the substantially ring-shaped portion 1 without difficulty. A base portion (stem portion) 2c of the substantially Y-shaped portion 2 is one stem. An intersection position 3c between the diverged portion (branch portion) 2a and the diverged portion (branch portion) 2b is a tip end portion of the base portion (stem portion) 2c.

The substantially ring-shaped portion 1 and the substantially Y-shaped portion 2 are integrally formed. This will be understood from the fact that the product X has been obtained by an additive manufacturing technology. Some carbon fibers that exist while being dispersed in the thermosetting resin are longer than {(length of circumference of substantially ring-shaped portion 1)+(length of substantially Y-shaped portion 2)}. Therefore, some carbon fibers will be present across the substantially ring-shaped portion 1 and the substantially Y-shaped portion 2.

The diverged portions 2a and 2b are slightly curved (an opening angle is, for example, about 160 to 175° (for example, 170°)) near intermediate positions (for example, about ⅔ of the entire lengths from the tip end portions 3a and 3b) 3d of the diverged portions 2a and 2b. The base portion 2c is bent at an intermediate position 3e (an opening angle is, for example, about 125 to 145° (for example, 135°)). The lengths of the diverged portions 2a and 2b are about 40 mm. The widths of the diverged portions 2a and 2b are larger than the width of the substantially ring-shaped portion 1 in order to securely support the substantially ring-shaped portion 1 even when the thicknesses of the thick portions of the diverged portions 2a and 2b are substantially the same as the thickness of the substantially ring-shaped portion 1. The widths of the diverged portions 2a and 2b are about 3.2 mm. The thicknesses at the thick portions of the diverged portions 2a and 2 b are about 2.3 mm. The thicknesses at the thin portions of the diverged portions 2a and 2b are about 1 mm. The length of the base portion 2c is about 35 mm. The width at the tip end portion (intersection position between the diverged portion 2a and the diverged portion 2b) 3c of the base portion 2c is about 7 mm. The width of the base portion (stem portion) 2c at the bent position 3e is about 4.6 mm. The thickness at the tip end portion 3c of the base portion 2c is about 2.5 mm. The thickness of the base portion 2c at the bent position 3e is about 2.7 mm. The thickness at the base end portion 3f of the base portion 2c is about 1 mm. The width of the base portion 2c substantially monotonically decreases from the tip end portion 3c toward the base end portion 3f. The thickness of the base portion 20 monotonically increases from the tip end portion 3c toward the bent position 3e. The reason why the thickness is increased is to secure the mechanical strength of the base portion 2c because the width of the base portion 2c is sequentially narrowed. The thickness decreases from the bent position 3e toward the base end portion 3f. However, the degree of decrease from a substantially intermediate position between the bent position 3e and the base end portion 3f toward the base end portion 3f rapidly increases. The thickness of a portion where the base portion 2c is attached to a fishing rod (a portion from the substantially intermediate position between the bent position 3e and the base end portion 3f to the base end portion 3f) is reduced in order to easily fix the base portion 2c to the fishing rod.

4a and 4b denote thick portions (ribs) in the diverged portions 2a and 2b. 5a and 5b denote thin portions in the diverged portions 2a and 2b. The thick portions (ribs) 4a and 4b are located at outer sides in the diverged portions 2a and 2b. The thin portions 5a and 5b are located at inner sides (opening 6 sides configured by the diverged portions 2a and 2b) in the diverged portions 2a and 2b. “Thick” of the thick portions means being “thick” as compared with the “thickness” of the thin portions. The thicknesses at the thick portions (ribs) 4a and 4b are the thicknesses (about 2.3 mm) at the diverged portions 2a and 2b. The widths at the thick portions (ribs) 4a and 4b are about 1 mm. The widths at the thin portions 5a and 5b are about 2.2 mm.

A thin portion has also been formed in the substantially ring-shaped portion 1. A thin portion 7a is formed in the substantially ring-shaped portion 1 at a position sandwiched between the diverged portion 2a and the diverged portion 2b. The thin portion 7a has a width of about 1 mm. A thick portion 7b has a width of about 0.6 mm. The thick portion 7 b has a thickness of about 2.3 mm. The thin portion 7a has a thickness of about 1 mm.

### Comparative Example 1

In Example 1, no rib was formed.

Due to the presence of the ribs, weight reduction could be achieved while maintaining necessary rigidity. That is, when comparing the fishing rod equipped with the fishing line guide of Example 1 with the fishing rod equipped with the fishing line guide of Comparative Example 1, the fishing rod equipped with the fishing line guide of Example 1 was much easier to use.

### REFERENCE SIGNS LIST

1 Substantially ring-shaped portion
2 Substantially Y-shaped portion
2a, 2b Diverged portion (branch portion)
2c Base portion (stem portion)
3a, 3b Tip end portion
3c Intersection position between diverged portion (branch portion) 2a and diverged portion (branch portion) 2b
3e Bent position
3f Base end portion
4a, 4b, 7b Thick portion (rib)
5a, 5b, 7a Thin portion
6 Opening

1-11. (canceled)

12. A fishing line guide, comprising
a main body portion of the fishing line guide is made of a fiber-containing resin composition,
the main body portion includes a rib,
the main body portion includes a substantially ring-shaped portion and a substantially Y-shaped portion,
tip end portions of diverged portions of the substantially Y-shaped portion are connected to the substantially ring-shaped portion,
the rib is formed in the diverged portion, and
an inner part of the diverged portion is thin, an outer part of the diverged portion is thick, and the thick part is the rib.

13. The fishing line guide according to claim 12, further comprising a second rib that is formed on the substantially ring-shaped portion at a position sandwiched by the diverged portions, and
in the substantially ring-shaped portion, an outer part of the substantially ring-shaped portion at a position sandwiched by the diverged portions is thin, an inner part of the substantially ring-shaped portion at the sandwiched position is thick, and the thick part is the second rib.

14. The fishing line guide according to claim 12, wherein
carbon fibers are used as the fibers.

15. The fishing line guide according to claim 12, wherein
the fibers a length of 1 cm or more.

16. The fishing line guide according to claim 12, wherein the fibers are present across the substantially ring-shaped portion and the substantially Y-shaped portion.

17. The fishing line guide according to claim 12, wherein the fiber-containing resin composition comprises a thermosetting resin.

18. The fishing line guide according to claim 12, wherein
fiber-containing resin composition satisfies (amount of the resin)/(amount of the resin+amount of the fibers)=30/100 to 60/100.

19. The fishing line guide according to claim 12, wherein
the fishing line guide has a water absorption rate of 2.0% or less.

20. The fishing line guide according to claim 13, wherein
a thickness of the rib on the diverged portion is substantially the same as a thickness of the second rib on the substantially ring-shaped portion.

21. A method for manufacturing a fishing line guide according to claim 12, wherein
a main body portion of the fishing line guide is made of a fiber-containing resin composition, and
the method comprises: shaping a resin composition having fibers with a 3D printer to obtain a shaped object; and a heating and pressurizing the shaped object.

22. The method according to claim 21, wherein
the pressurizing further comprises use of a mold,
the mold includes a half-mold A and a half-mold B,
in the half-mold A and the half-mold B, a recess having no corners on a concave surface is formed on each of the surfaces opposed to each other of the half-mold A and the half-mold B, and
the shaped object is disposed in the recess of the half-mold A, and is then covered with the half-mold B, heated and pressurized.
